(19) United States
(12) Patent Application Publication
(10) Pub. No.: US 2005/0094017 A1
(43) Pub. Date: May 5, 2005

(54) Image display apparatus, image display method, and record medium

(75) Inventor: Katsumi Hirakawa, Sagamihara (JP)

Correspondence Address: SCULLY, SCOTT, MURPHY & PRESSER, 400 Garden City Plaza - Ste. 300, Garden City, NY, 11530, US

(73) Assignee: Olympus Corporation, Tokyo (JP)

(21) Appl. No.: 10/980,598

(22) Filed: Nov. 3, 2004

(30) Foreign Application Priority Data
Nov. 4, 2003 (JP) 2003-373924
Dec. 19, 2003 (JP) 2003-423661

(51) Int. Cl. H04N 5/222

(52) U.S. Cl. 348/333.01

(57) ABSTRACT

An image display apparatus includes a detection unit for detecting image information having a predetermined characteristic; a generation unit for generating a scale converted image which is an enlarged image or a reduced image of an image related to the image information detected by the detection unit; and a display unit for displaying the scale converted image generated by the generation unit. The display unit switches the display format of the scale converted image and displays the image as necessary.

### CROSS REFERENCE TO RELATED APPLICATIONS

This application is based upon and claims the benefit of priority from the prior Japanese Patent Applications No. 2003-373924, filed Nov. 4, 2003; No. 2003-423661, filed Dec. 19, 2003, the entire contents of all of which are incorporated herein by reference.

### BACKGROUND OF THE INVENTION

1. Field of the Invention

The present invention relates to an image display apparatus, an image display method, and a record medium storing an image display program.

2. Description of the Related Art

Recently, a swallow-type capsuled endoscope has been developed in the field of an endoscope (for example, refer to the specifications of U.S. Patent Laid-open Application No. 2002/0177779A1). This capsuled endoscope has the image pickup function and the wireless communications function. After a patient swallows it for observation (inspection), it sequentially captures the internal organs of the patient such as the stomach, the small intestine, etc. until it is naturally excreted from the body so that captured image information (electronic data representing an image) can be sequentially transmitted by wireless.

Thus, the image information transmitted by wireless is received by the receiver provided outside the body of the patient, stored in predetermined memory, and then used for diagnosis, etc. by a doctor by reading and displaying the information on the display unit as necessary.

### SUMMARY OF THE INVENTION

An aspect of the present invention is an image display apparatus including a detection unit for detecting image information having a predetermined characteristic; a generation unit for generating a scale converted image which is an enlarged image or a reduced image of an image related to the image information detected by the detection unit; and a display unit for displaying the scale converted image generated by the generation unit. The display unit switches the display format of the scale converted image and displays the image as necessary.

### BRIEF DESCRIPTION OF THE DRAWINGS

FIG. 1 shows the entire configuration of the capsuled endoscope system to which the image display apparatus according to an embodiment of the present invention is applied;

FIG. 2 shows the configuration of the system of the workstation;

FIG. 3 is a flowchart of the displaying operation of the workstation according to the embodiment 1 of the present invention;

FIG. 4 shows an example of the display screen according to the listing display displayed on the display unit in S6;

FIG. 5 shows an example of the display screen according to the sequential display displayed on the display unit in S9;

FIG. 6 shows another example of the display screen relating to the listing display of the present invention; and

FIG. 7 is a flowchart of the displaying operation of the workstation according to the embodiment 2 of the present invention.

### DESCRIPTION OF THE PREFERRED EMBODIMENTS

The embodiments of the present invention are explained below by referring to the attached drawings.

### Embodiment 1

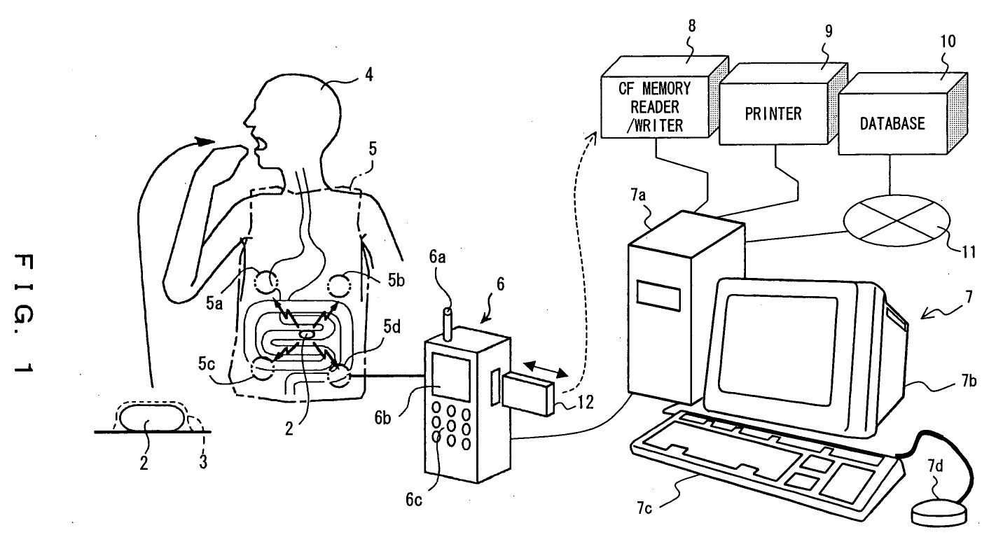

FIG. 1 shows the entire configuration of the capsuled endoscope system to which the image display apparatus according to an embodiment of the present invention is applied.

A capsuled endoscope system 1 shown in FIG. 1 comprises a capsuled endoscope 2 and its package 3, a jacket 5 for a patient 4, a receiver 6 removable from the jacket 5, a workstation 7 which is an image display apparatus according to the present embodiment, a CF (CompactFlash (registered trademark)) memory reader/writer 8, a printer 9, a database 10, a network 11, etc.

The capsuled endoscope 2 is provided with a capture unit and a wireless communications unit not shown in FIG. 1. The image information (image information about a captured image) captured by the capture unit can be externally transmitted by wireless by the wireless communications unit.

The jacket 5 is provided with antennas 5a, 5b, 5c, and 5d for capturing the electric wave about the image information about the captured image transmitted from the wireless communications unit of the capsuled endoscope 2. The antennas are mounted for communications by cable or wireless with the receiver 6.

The receiver 6 is provided with an antenna 6a used in receiving image information through electric waves directly from the jacket 5, a display unit 6b for displaying information required for observation (inspection), and an input unit 6c for inputting information required for observation (inspection). The receiver 6 can be provided with a removable CF memory 12 storing received image information.

The workstation 7 comprises a body 7a, a display 7b, a keyboard 7c, a mouse 7d, etc., and has the processing function for performing diagnosis by a doctor, etc. based on the image of the internal organs of a patient captured by the capsuled endoscope 2. The workstation 7 comprises an interface connected to be able to communicate with each of the receiver 6, the CF memory reader/writer 8, and printer 9, and performs a read from and write to the CF memory 12, prints a patient chart, etc. The workstation 7 displays an image of the internal organs, etc. on the display 7b according to the image information about the captured image in the body of a patient transferred from the receiver 6. Furthermore, the workstation 7 has the communications function for connection to the network 11, and stores an observation result, etc. of a patient in the database 10. The database 10 can be included in the workstation 7 instead of being obtained over the network 11.

As shown in FIG. 1, before starting an inspection, the capsuled endoscope 2 is taken from the package 3. When the capsuled endoscope 2 is swallowed by a patient, it passes through the gorge, proceeds in the coelom by the peristalsis of the alimentary canal, and sequentially captures images of the coelom. Then, as necessary or at any time, the electric waves of the image information about a captured image are output from the capsuled endoscope 2 as a result of the capture, and the respective electric waves at the antennas 5a, 5b, 5c, and 5d of the jacket 5 are captured. Then, a signal from an antenna 5 having a received electric wave of high intensity is transmitted to the receiver 6 outside the body of the patient.

In the receiver 6, the image information about captured images to be sequentially received is stored in the CF memory 12. The receiver 6 is not synchronous with the start of the capture of the capsuled endoscope 2, but the start and the end of reception is controlled by the operation of the input unit 6c. The image information about a captured image can be the image information about still images captured as a plurality of frames/second for display as dynamic images, or the image information about a normal dynamic image. In this example, the image information about a still image in the present embodiment is used.

When the observation (inspection) of the patient 4 using the capsuled endoscope 2 is completed, the image information about the captured image stored in the CF memory 12 is transferred to the workstation 7 through the cable, or the CF memory 12 storing the image information about the captured image is attached to the CF memory reader/writer 8, and the image information about the captured image can be transferred to the workstation 7 through the CF memory reader/writer 8.

In the workstation 7, the transferred image information about the captured image is stored for each patient, the image information about the captured image of a specific patient is read as necessary, and displayed on the display 7b. Thus, useful data for physiological study can be obtained and various lesions can be diagnosed for all alimentary canals of a human body to the depth (small intestine, etc.) that cannot be reached by an ultrasonic probe, an endoscope, etc.

Since the capsuled endoscope 2 travels with the peristalsis of the alimentary canal as described above, it captures an image at a predetermined capture rate (for example, 2 fps) while repeating traveling and stopping with the peristalsis. Therefore, although the total number of the captured images related to the image information is enormously large, there are a number of images indicating almost no color change in the images continuous in a time series.

In the workstation 7, when a large number of images containing the above-mentioned images continuous in a time series and indicating almost no color change are to be displayed, there is an appropriate display method for easily grasping the large number of images and easily retrieving from among the large number of images a desired image, for example, an image of an affectional portion.

The configuration and the operation of the workstation 7 are explained below further in detail.

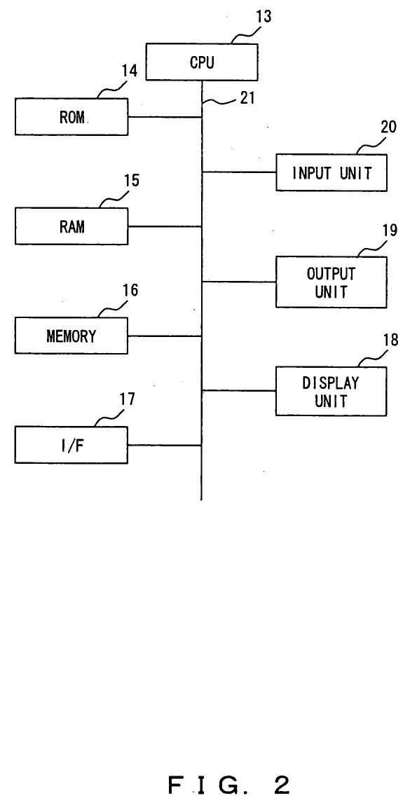

FIG. 2 shows the configuration of the system of the workstation 7.

The workstation 7 comprises a CPU 13, ROM 14, RAM 15, memory 16, an I/F 17, a display unit 18, an output unit 19, an input unit 20, etc. Each of them is connected via a bus 21 so that data can be transmitted and received as necessary.

The CPU 13 controls the operation of the entire workstation 7 by reading the control program (including the image display program) stored in advance in the ROM 14. The ROM 14 stores necessary data for various processes in addition to the control program. The RAM 15 is used for temporary storage of image information input through the I/F 17 or image information for use during various image processing, or as a work area, etc. for execution of a control process by the CPU 13. The memory 16 is a large-capacity memory storing image information input through the I/F 17, and can be, for example, a hard disk, etc. The I/F 17 is an interface for allowing the receiver 6 and the CF memory reader/writer 8 to communicate data. The display unit 18 corresponds to the above-mentioned display 7b, and displays images, etc. relating to the image information. The output unit 19 performs various outputting processes with the printer 9 or with the database 10, etc. over the network 11. The input 20 corresponds to the above-mentioned keyboard 7c, the mouse 7d, etc., and inputs various data depending on the instructing operation of a doctor, etc.

The displaying operation of the workstation 7 is explained below The displaying operation is one of the operations performed by the CPU 13 reading a control program stored in the ROM 14.

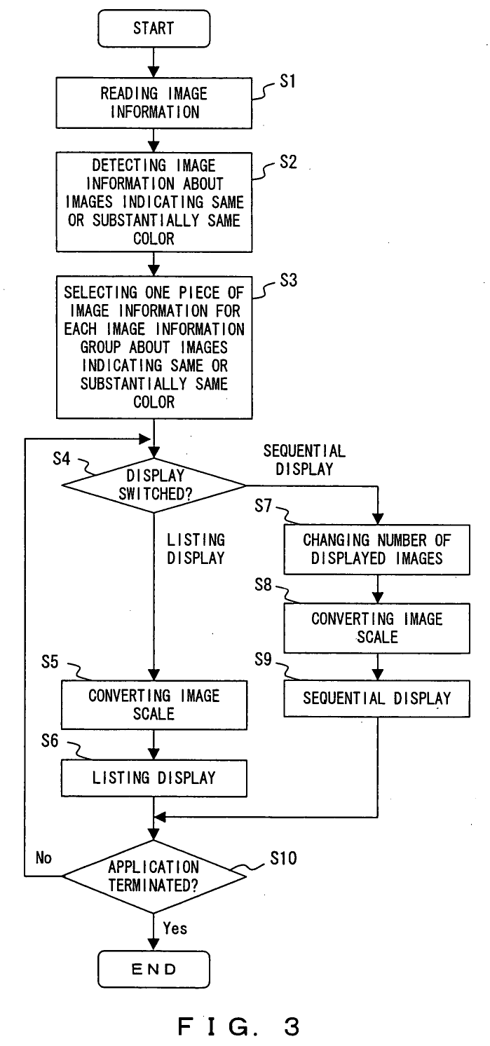

FIG. 3 is a flowchart of the displaying operation of the workstation 7.

In this operation, the image information about the captured image of a specific patient is read from the memory 16 (step (hereinafter referred to simply as “S”) 1).

When the operation of this flowchart is started, the image information captured by the capsuled endoscope 2 is assumed to be stored in the memory 16 as explained above by referring to FIG. 1.

Then, the image information about the image indicating the same or substantially the same color is detected as the image information having a predetermined characteristic from the image information read in S1 (S2). The information is detected by, for example, obtaining color information or a brightness value from image information, and detecting the image information containing substantially the same information as the obtained color information in the same or a predetermined range as the image information about the image indicating the same or substantially the same color. To be more practical, an average value (or any other statistical value can be used) of color information is obtained from image information, and the image information containing the obtained average value of the color information in the same or a predetermined range is detected as the image information about an image indicating the same or substantially the same color. The image information when color information is obtained can be the image information about one image or the image information about one or more predetermined areas of one image.

Then, in the image information detected in S2 about an image indicating the same or substantially the same color, each piece of image information is selected for each image information group having continuous frame numbers, that is, for each image information group of continuous information in a time series (S3). In this embodiment, it is assumed that a piece of image information having the smallest frame number in the image information belonging to the image information group is selected, but it is also possible to select the image information having the largest frame number. A frame number is assigned to the image information in a time series based on the capture date and time, etc. In the present embodiment, the older the capture date and time, the smaller the frame number. That is, the latest capture date and time has the largest frame number.

Then, based on the instructing operation of a user such as a doctor, etc. using the keyboard 7c or the mouse 7d, it is determined which is indicated by the display switch instruction, listing display or sequential display (S4).

If the determination result in S4 is a display switch instruction for listing display, then the scale conversion is performed for the listing display on each of the images related to the image information selected in S3, a scale converted image (which can be thumbnail images) is generated (S5), And the scale converted image is displayed in a listing display format on the display 7b (S6). Thus, only an image indicating a color change is displayed in a listing display format.

On the other hand, if the determination result in S4 is a display switch instruction for sequential display, the set number of displayed images is changed into the number of displayed images indicated by the switch instruction (S7). According to the present embodiment, the number of displayed images which can be indicated by a switch instruction is assumed to be 1, 2, or 4. The switch instruction of the number of displayed images can change the image size of the scale converted image generated in S8 described later.

Then, a scale converted image which can be an enlarged image or a reduced image is generated depending on the set number of displayed images (S8), and the scale converted image is displayed in a sequential display format on the display 7b (S9). Thus, only an image indicating a color change is displayed in a sequential display format.

After S6 or S9, it is determined by the instructing operation of a user such as a doctor, etc. using the keyboard 7c or the mouse 7d whether or not an execution complete instruction for the application relating to the present operation has been issued (S10). If the determination result is YES, the present operation terminates. If NO, control is returned to S4, and the above-mentioned processes are repeated.

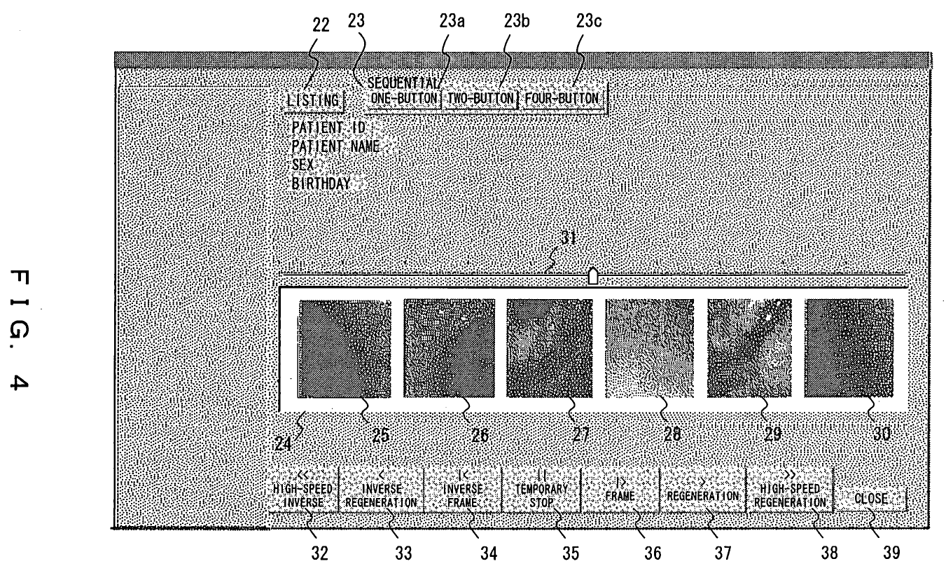

FIG. 4 shows an example of a display screen of listing display displayed on the display 7b in S6.

In FIG. 4, a listing button 22 for a display switch instruction for listing display, and a one-button 23a, a two-button 23b, and a four-button 23c for a switch instruction for the number of displayed images for the sequential display in a sequential button area 23 for a display switch instruction for sequential display are provided at the upper portion on the display screen. In S4 above, the listing button 22 or any of the buttons 23a, 23b, and 23c on in the sequential button area 23 is pressed by the instructing operation using the keyboard 7c or the mouse 7d, thereby issuing the display switch instruction. By any of the one-button 23a, the two-button 23b, and the four-button 23c pressed by the instructing operation using the keyboard 7c or the mouse 7d, a switch instruction of the number of displayed images is issued.

Below the listing button 22, a patient ID, a patient name, sex, and his or her birthday are displayed as the information about the patient whose image is to be displayed.

An image display column 24 is provided at the center of the display screen. In the image display column 24, the six scale converted images (which can be thumbnail images) generated in S5 above are displayed in a time series. In the six scale converted images, frame numbers are assigned to the images in an ascending order from left to right. That is, the rightmost image arranged is assigned the largest frame number. In this embodiment, scale converted images 25, 26, 27, 28, 29, and 30 are displayed in the ascending order of the frame numbers. The frame numbers of the scale converted images are the same as the image information of the generation source.

On the display screen, although there are seven or more scale converted images generated in S5 above, the remaining scale converted images can be displayed on the image display column 24 by moving a slider 31 left or right in the instructing operation using the keyboard 7c or the mouse 7d. For example, by the slider 31 moving to the left by the move instruction, a scale converted image having a smaller frame number than the scale converted image 25 can be displayed. Similarly, by the slider 31 moving to the right by the move instruction, a scale converted image having a larger frame number than the scale converted image 30 can be displayed.

Below the image display column 24, a high-speed inverse regeneration button 32 for high-speed regeneration in the inverse direction (in the direction toward a smaller frame number), an inverse regeneration button 33 for normal regeneration in the inverse direction, an inverse frame button 34 for frame regeneration in the inverse direction, a temporary stop button 35 for temporary stop of regeneration, a frame button 36 for frame regeneration in the forward direction (in the direction toward a larger frame number), a regeneration button 37 for normal regeneration in the forward direction, and a high-speed regeneration button 38 for high-speed regeneration in the forward direction are provided as the buttons for regeneration of an image to be displayed in the image display column 24.

For example, on the display screen for listing display, when the inverse frame button 34 or the frame button 36 is pressed, the scale converted image listed in the image display column 24 is shifted by one. If the inverse regeneration button 33 or the regeneration button 37 is pressed, every image or every sixth image of the displayed scale converted images is changed and regenerated every first or sixth image. If the high-speed inverse regeneration button 32 or the high-speed regeneration button 38 is pressed, every sixth image of the displayed scale converted images is changed and regenerated at a high speed.

A close button 39 is provided to the right diagonally below the display screen, and by pressing the close button 39, this display screen is closed.

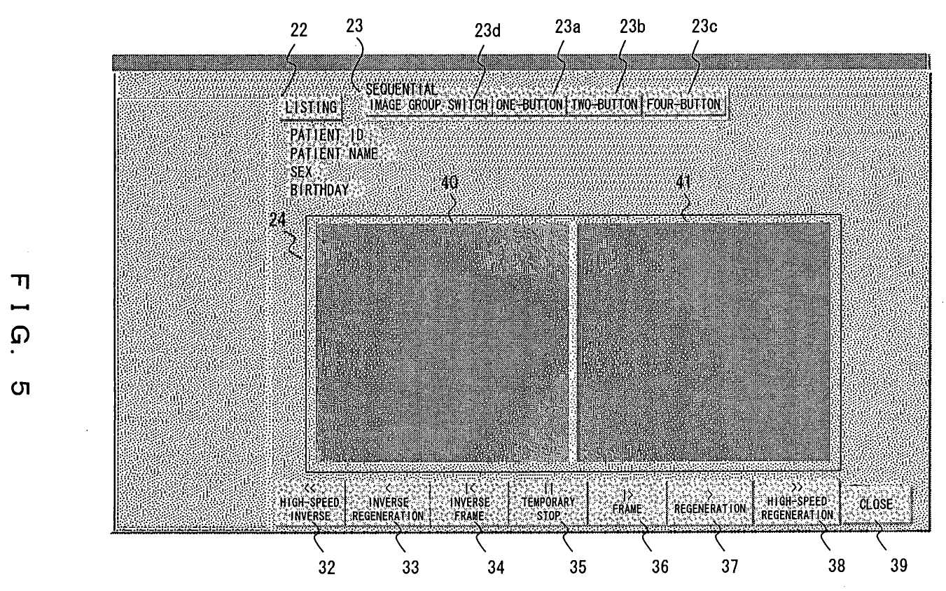

FIG. 5 shows an example of the display screen for sequential display displayed on the display 7b in S9. However, the display screen in FIG. 5 indicates the display screen displayed when the two-button 23b is pressed.

As shown in FIG. 5, when the two-button 23b is pressed, two scale converted images which can be an enlarged image or a reduced image generated in S8 is displayed in a time series in the image display column 24, and the two scale converted images are displayed with an image having a smaller frame number on the left. In this example, scale converted images 40 and 41 are displayed.

On this display screen, although there are three or more scale converted images generated in S8 above, the remaining scale converted images not being displayed in the image display column 24 can be displayed by pressing the high-speed inverse regeneration button 32, the inverse regeneration button 33, the inverse frame button 34, the temporary stop button 35, the frame button 36, the regeneration button 37, and the high-speed regeneration button 38. For example, by pressing the inverse frame button 34 or the frame button 36, the scale converted images not being displayed in the image display column 24 can be shifted and displayed one by one. If the inverse regeneration button 33 or the regeneration button 37 is pressed, the scale converted images not being displayed can be regenerated in two units, and when the temporary stop button 35 is pressed as necessary, the update of display can be stopped with two desired scale converted images displayed. When the high-speed inverse regeneration button 32 or the high-speed regeneration button 38 is pressed, the two scale converted images not being displayed can be regenerated in two units at a high speed. When the temporary stop button 35 is pressed as necessary, two desired scale converted images can be displayed.

On the display screen for sequential display, an image group switch button 23d is newly provided. By pressing the image group switch button 23d, a target to be displayed in the image display column 24 can be switched to a specific scale converted image group of an image information group having continuous frame numbers and indicating the same or substantially the same color. For example, when one scale converted image displayed in the image display column 24 is indicated in the instructing operation by the instructing operation of a user such as a doctor, etc. using the keyboard 7c or the mouse 7d, and the image group switch button 23d is pressed, thereby displaying in the image display column 24 and confirming the scale converted image group of the image information group to which the image information that is the source of the indicated scale converted image belongs. However, the scale converted image displayed at this time is generated by the scale conversion as in the process in S8 above.

FIG. 5 shows the display screen for sequential display displayed when the two-button 23b is pressed. However, when the one-button 23a is pressed, one scale converted image generated by the scale conversion when the number of displayed images is 1 is displayed. When the four-button 23c is pressed, four scale converted images generated by the scale conversion when the number of displayed images is 4 are displayed in a time series. For example, when the number of displayed images is 1, then one scale converted image which is an enlarged image is displayed. When the number of displayed images is 4, four scale converted images which are reduced images are displayed. In this case, as described above, by pressing the high-speed inverse regeneration button 32, the inverse regeneration button 33, the inverse frame button 34, the temporary stop button 35, the frame button 36, the regeneration button 37, and the high-speed regeneration button 38, the remaining scale converted images not being displayed can be displayed.

As described above, according to the present embodiment, one scale converted image can be generated and displayed for each image information group for images indicating the same or substantially the same color and having continuous frame numbers, thereby displaying only an image indicating a color change. Therefore, a user such as a doctor, etc. only has to confirm the image indicating a displayed color change to easily grasp the images related to a large amount of image information. Furthermore, when a desired image, for example, an image including a captured affectional portion can be easily found based on the image indicating a color change.

Additionally, the display format of the scale converted images can be switched between listing display and sequential display, and the number of displayed images can be changed in the sequential display. Therefore, a user such as a doctor, etc. can confirm an image indicating a color change in a desired display format.

Furthermore, since scale converted images can be displayed for each image information group of images having continuous frame numbers and indicating the same or substantially the same color, it is not necessary to confirm many times the same portion of an image captured at different angles.

In the present embodiment, as explained above by referring to FIG. 5, a target to be displayed in the sequential display format can be switched to a specific scale converted image group of an image information group having continuous frame numbers and indicating the same or substantially the same color. For example, similarly in the listing display format, a target to be listed can also be switched to a specific scale converted image group of an image information group having continuous frame numbers and indicating the same or substantially the same color.

In the present embodiment, in the displaying operation explained by referring to FIG. 3, a scale converted image of an image related to the image information selected in S3 is generated in S5, and the scale converted image is displayed in the listing display format in S6. However, for example, in S5, a scale converted image can be generated by the scale conversion for listing display for all image information about the images indicating the same or substantially the same color detected in S2, and in S6, a scale converted image group generated from the image information group about the images having continuous frame numbers and indicating the same or substantially the same color can be defined as one group and displayed in a listing display format.

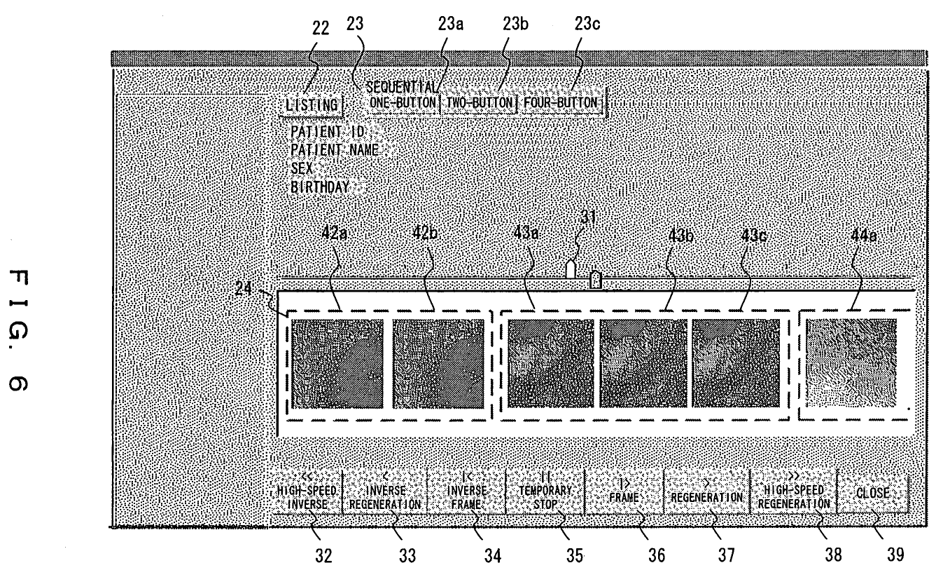

FIG. 6 shows an example of a display screen for listing display in the above-mentioned case.

As shown in FIG. 6, a scale converted image group generated from an image information group related to the images having continuous frame numbers and indicating the same or substantially the same color can be indicated by dotted lines as one group and displayed in the listing display format in the image display column 24. In the example shown in FIG. 6, a scale converted image group comprising scale converted images 42a and 42b is indicated as one group, a scale converted image group comprising scale converted images 43a, 43b, and 43c is indicated as one group, a scale converted image group comprising a scale converted image 44d, etc. is indicated as one group, and the groups are displayed in the listing display format. The scale converted images 42a, 43a, and 44a are the same as the scale converted images 26, 27, and 28 shown in FIG. 4.

In the display screen shown in FIG. 6, the remaining scale converted images not being displayed can be displayed by moving the slider 31 by a move instruction. Furthermore, by pressing the high-speed inverse regeneration button 32, the inverse regeneration button 33, the inverse frame button 34, the temporary stop button 35, the frame button 36, the regeneration button 37, and the high-speed regeneration button 38, the corresponding scale converted images can be regenerated.

### Embodiment 2

The present embodiment is different from the embodiment 1 in a displaying operation of the workstation 7. That is, in the present embodiment, the workstation 7 detects image information having predetermined color information as image information having a predetermined characteristic from a large amount of image information captured by the capsuled endoscope 2. Hereafter, as in the embodiment 1, image information is selected for each image information group having continuous frame numbers in the detected image information, and the selected image information is displayed in the display format depending on the display switch instruction.

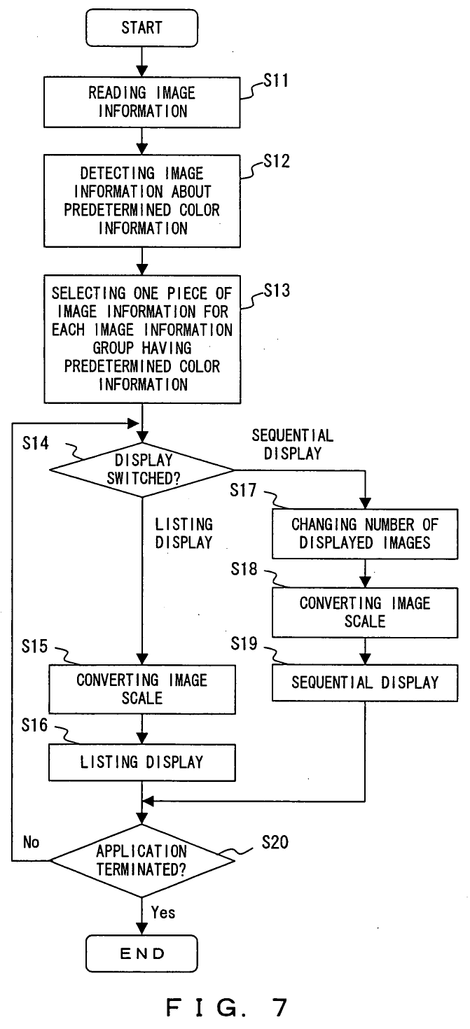

FIG. 7 is a flowchart of the displaying operation of the workstation 7. As in the embodiment 1, the present operation is also performed by reading a control program stored in the ROM 14 in advance by the CPU 13 and executing the program.

In FIG. 7, first in S11, as in S1 (refer to FIG. 3) above, the image information about the captured image of a specific patient is read from the memory 16. When the operation according to the present flowchart is started, as in the embodiment 1, a large amount of image information captured by the capsuled endoscope 2 is stored in the memory 16 by patient.

Then, in S12, image information having predetermined color information is detected from the image information read in the previous step. In this embodiment, with a view to displaying only an image indicating a bloodshedding portion, color information with which it can be determined that image information is related to an image captured as a bloodshedding portion is predetermined, and the image information indicating the color information is detected. In this case, the image information can be detected by statistically obtaining in advance an average value of pixel values of the entire image with which it can be determined that the captured image indicates a bloodshedding portion, and by detecting the information containing an average value of pixel values of the entire image related to the image information to be detected, or the information containing an average value of pixel values in one or more predetermined areas of the image related to the image information to be detected in a predetermined range having the average value as a central value or in a predetermined range including the average value as the image information related to the captured image indicating a bloodshedding portion.

Then, in S13, in the image information detected in the previous step, each piece of image information is selected for each image information group having continuous frame numbers. In this embodiment, a piece of image information selected from an image information group is defined as the image information having the smallest frame number as in the previous S3 (refer to FIG. 3). However, the information can also be defined as having the largest frame number.

The processes in S14 through S20 are the same as the processes in the previous S4 through S10 (refer to FIG. 3).

That is, in S14, when a user such as a doctor, etc. issues a display switch instruction for listing display, control is passed to S15, the scale conversion is performed for listing display of each image related to the image information selected in S13 to generate a scale converted image, and the scale converted image is displayed in the listing display format on the display 7b (S16).

Otherwise, in S14, when a display switch instruction for sequential display is issued, control is passed to S17, and the number of displayed images is changed into the number based on the display switch instruction. In the present embodiment, the image size of the generated scale converted image depends on the set number of displayed images. For each of the images related to the image information selected in S13, the scale conversion is performed based on the number of displayed images set in S17, thereby generating a scale converted image which is an enlarged image or a reduced image (S18), and the scale converted images depending on the number of displayed images are displayed in the sequential display format on the display 7b (S19).

After S16 or S19, at an instruction of a doctor, etc., it is determined whether or not the execution complete instruction of an application according to the present operation has been issued (S20). If the determination result is YES, the present operation terminates. If the determination result is NO, then control is returned to S14, and the above-mentioned process is repeated.

In the present operation, in S16, for example, scale converted images are listed as in the listing display shown in FIG. 4 above, and in S19, the scale converted images are sequentially displayed as in the sequential display shown in FIG. 5.

As described above, according to the present embodiment, only an image related to the image information detected from among a large amount of image information captured by the capsuled endoscope as the image information about the image captures as a bloodshedding portion can be displayed. Therefore, a doctor, etc. can easily confirm the image captured as a bloodshedding portion without confirming the image about all image information. Furthermore, since the display format can be switched to listing display or sequential display, a doctor, etc. can switch into a desired and recognizable display format as necessary. The image displayed at this time is an image related to the image information selected piece by piece for each image information group having continuous frame numbers. Therefore, a doctor, etc. can be free of confirming many times the images of the same portion taken at different angles, thereby efficiently confirming an image taken as a bloodshedding portion.

In the displaying operation shown in FIG. 7 according to the present embodiment, for example, in the sequential display performed in S19, as explained above by referring to FIG. 5, a target to be displayed can be switched to a specific scale converted image group relating to an image information group having continuous frame numbers in the image information detected as the image information related to the image captured as a bloodshedding portion. Similarly, in the listing display, a target to be displayed can be switched to a specific scale converted image group relating to an image information group having continuous frame numbers in the image information detected as the image information related to the image captured as a bloodshedding portion.

Furthermore, in the displaying operation shown in FIG. 7 according to the present embodiment, for example, in S15, a scale converted image is generated by performing the scale conversion for listing display on the image related to all image information detected in S12. In subsequent S16, a scale converted image group generated from the image information group having continuous frame numbers is indicated as one group so that the scale converted images can be listed. In this case, for example, as in the listing display shown in FIG. 6 as described above, the scale converted image group is enclosed by the dotted lines for each scale converted image group having continuous frame numbers.

Additionally, in the displaying operation shown in FIG. 7 according to the present embodiment, in S12, the image information having color information which can be determined as the image information related to the image captured as a bloodshedding portion can be detected as the image information having predetermined color information, but the image information having another color information can be detected for the image to be displayed.

In the workstation 7 according to the above-mentioned embodiment 1 and 2, the control program for controlling the above-mentioned displaying operation is stored in the ROM 14, but the control program can be stored in a portable record medium such as CD-ROM, a DVD, a floppy (registered trademark) disk, etc. or a storage device of a program provider, and can be read by the workstation 7. For example, when the control program is stored in a portable record medium, the portable record medium can be inserted into the drive device not shown in the attached drawings and the control program can be read, and the read control program can be executed after being stored in the storage unit of the RAM 15, the memory 16, etc. Otherwise, when the control program is provided by a program provider through a communications circuit (network 11, etc.), the control program stored in the storage device or memory, etc. of the program provider is received by the workstation 7 through the communications circuit, and the received program is stored in the storage unit of the RAM 15, the memory 16, etc. and executed. Otherwise, the control program can be stored in the memory 16 in advance, and then executed. The control program stored in the record medium, etc. can realize a part of the above-mentioned displaying operation.

As the image information having a predetermined characteristic, the image information related to the images indicating the same or substantially the same color is detected in the embodiment 1, and the image information having predetermined color information is detected in the embodiment 2. It is also possible to detect the image information having another characteristic as necessary.

In the embodiments 1 and 2, the image information processed by the workstation 7 is obtained in a time series by the capsuled endoscope 2. However, the image information can be obtained in a time series by another medical device, or the image information obtained in another time series can be used.

Furthermore, in the embodiments 1 and 2, the number of displayed images simultaneously listed is not limited to 6, or the number of displayed images sequentially displayed is not limited to 1, 2, or 4.

The present invention is described above in detail, but it is not limited to the above-mentioned embodiments, and it is obvious that the present invention can be realized as various improvements and variations within the scope of the gist of the present invention.

According to the present invention, a large amount of image information can be easily grasped, and desired image information can be easily detected from a large amount of image information.

1. An image display apparatus, comprising:
a detection unit detecting image information having a predetermined characteristic;
a generation unit generating a scale converted image which is an enlarged image or a reduced image of an image related to the image information detected by said detection unit; and
a display unit displaying the scale converted image generated by said generation unit, wherein
said display unit switches a display format of the scale converted image and displays the image as necessary.

2. The apparatus according to claim 1, wherein
said detection unit detects image information about images indicating a same or substantially a same color as image information having the predetermined characteristic.

3. The apparatus according to claim 1, wherein
said detection unit detects image information having predetermined color information as image information having the predetermined characteristic.

4. The apparatus according to claim 1, wherein
said display unit switches a display format of the scale converted image to at least listing display or sequential display, and displays the image as necessary.

5. The apparatus according to claim 1, wherein
said display unit switches a display format of the scale converted image to a format of displaying different numbers of simultaneously displayed images, and displays the image as necessary.

6. The apparatus according to claim 1, wherein
said display unit switches a display format of the scale converted image to a format of displaying different image sizes, and displays the image as necessary.

7. The apparatus according to claim 4, wherein
the listing display or the sequential display of the scale converted image is performed for each image information group having continuous frame numbers in the image information detected by said detection unit.

8. The apparatus according to claim 7, wherein
said display unit comprises a switch unit switching an image information group having continuous frame numbers.

9. The apparatus according to claim 4, wherein
in the listing display, a scale converted image group of an image information group having continuous frame numbers is indicated as one group and listed in the image information detected by said detection unit.

10. The apparatus according to claim 1, wherein
the image information is obtained in a time series.

11. An image display method, comprising:
detecting image information having a predetermined characteristic;
generating a scale converted image which is an enlarged image or a reduced image of an image related to the detected image information; and
in displaying the generated scale converted image, switching a display format of the scale converted image as necessary.

12. The method according to claim 11, wherein
when detecting the information, image information about images indicating a same or substantially a same color is detected as image information having the predetermined characteristic.

13. The method according to claim 11, wherein
when detecting the information, image information having predetermined color information is detected as image information having the predetermined characteristic.

14. The method according to claim 11, wherein
when displaying the generated scale converted image, a display format of the scale converted image is switched to at least listing display or sequential display, and the image is displayed as necessary.

15. The method according to claim 11, wherein
when displaying the generated scale converted image, a display format of the scale converted image is switched to a format of displaying different numbers of simultaneously displayed images, and the image is displayed as necessary.

16. The method according to claim 11, wherein
when displaying the generated scale converted image, a display format of the scale converted image is switched to a format of displaying different image sizes, and the image is displayed as necessary.

17. The method according to claim 14, wherein
the listing display or the sequential display of the scale converted image is performed for each image information group having continuous frame numbers in the detected image information.

18. The method according to claim 17, wherein
an image information group having continuous frame numbers is switched.

19. The method according to claim 14, wherein
in the listing display, a scale converted image group of an image information group having continuous frame numbers is indicated as one group and listed in the detected image information.

20. The method according to claim 11, wherein
the image information is obtained in a time series.

21. A computer-readable storage medium storing an image display program used to direct a computer to realize:
a detecting function of detecting image information having a predetermined characteristic;
a generating function of generating a scale converted image which is an enlarged image or a reduced image of an image related to the image information detected by said detecting function; and
a displaying function of displaying a scale converted image, when displaying the scale converted image generated by said generating function, after switching a display format of the scale converted image as necessary.

22. The storage medium according to claim 21, wherein
said detecting function detects image information about images indicating a same or substantially a same color as image information having the predetermined characteristic.

23. The storage medium according to claim 21, wherein
said detecting function detects image information having predetermined color information as image information having the predetermined characteristic.

24. The storage medium according to claim 21, wherein
said displaying function displays the scale converted image generated by said generating function by switching a display format of the scale converted image to at least listing display or sequential display as necessary.

25. The storage medium according to claim 21, wherein
said displaying function displays the scale converted image generated by said generating function by switching a display format of the scale converted image to a format of displaying different numbers of simultaneously displayed images as necessary.

26. The storage medium according to claim 21, wherein
said displaying function displays the scale converted image generated by said generating function by switching a display format of the scale converted image to a format of displaying different image sizes as necessary.

27. The storage medium according to claim 24, wherein
the listing display or the sequential display of the scale converted image is performed for each image information group having continuous frame numbers in the image information detected by said detecting function.

28. The storage medium according to claim 27, wherein
said displaying function comprises a switching function of switching an image information group having continuous frame numbers.

29. The storage medium according to claim 24, wherein
in the listing display, a scale converted image group of an image information group having continuous frame numbers is indicated as one group and listed in the image information detected by said detecting function.

30. The storage medium according to claim 21, wherein
the image information is obtained in a time series.

31. An image display apparatus, comprising:
detection means for detecting image information having a predetermined characteristic;
generation means for generating a scale converted image which is an enlarged image or a reduced image of an image related to the image information detected by said detection means; and
display means for displaying the scale converted image generated by said generation means, wherein
said display means switches a display format of the scale converted image and displays the image as necessary.
